(19) United States
(12) Patent Application Publication
(10) Pub. No.: US 2026/0193146 A1
(43) Pub. Date: Jul. 9, 2026

(54) POLYHALITE GRANULES

(71) Applicant: ANGLO AMERICAN WOODSMITH LIMITED, London (GB)

(72) Inventors: Rafaella da Fonseca RODRIGUES, London (GB); Timothy David LEWIS, London (GB); Jonathan Richard Walton BROWN, London (GB)

(21) Appl. No.: 19/128,296

(22) PCT Filed: Nov. 10, 2023
(86) PCT No.: PCT/IB2023/061364

§ 371 Date: May 8, 2025

(30) Foreign Application Priority Data
Nov. 11, 2022 (GB) 2216878.5

(51) Int. Cl. C05D 1/02; C05D 1/00; C05G 5/12

(52) U.S. Cl. CPC C05D 1/02; C05D 1/005; C05G 5/12

(57) ABSTRACT

The invention provides a granular material comprising a polyhalite composition; 0.2% (w/w) to 2.0% (w/w) organic binder and 0.5% (w/w) to 6.0% (w/w) inorganic binder, wherein the ratio of inorganic binder to organic binder is greater than 1:1 and a process for preparation of the material. The invention further provides a granule comprising polyhalite or polyhalite in combination with potassium salt/s having a crush strength of from 2.0 kgf to 6.0 kgf and a final moisture content of from 0.25 to 0.50% w/w.

### INTRODUCTION

This invention relates to polyhalite granules and a process for the manufacture thereof. The polyhalite granules comprise polyhalite and/or polyhalite together with a potassium salt, for example from a source of potash, an organic binder and an inorganic binder.

### BACKGROUND OF THE INVENTION

Polyhalite granulation is a process having a good behavior when granulated without binders or with organic binders. However, a challenge arises in the high moisture uptake of the polyhalite granules, which drastically reduces the crush strength of the granulated product resulting in high levels of degradation and dust generation, even if no fines were present in the original granulated product. The aforementioned drawbacks particularly occur when starch is used as a binder because of the hygroscopic nature of starches results in the granules degrading under humid conditions. As such, a limitation of polyhalite granules with starch as the binder is that the physical integrity of the granules is poor for long periods of transport, handling and storage. The starch only provides physical interactions, not chemical, and such physical interactions deteriorate with time and with the action of microorganisms.

A need exists for a polyhalite granules that ameliorate the abovementioned problems.

### SUMMARY OF THE INVENTION

According to a first aspect of the present invention there is provided a granular material comprising:
a polyhalite composition;
0.2% (w/w) to 2.0% (w/w) organic binder; and
t 0.5% (w/w) to 6.0% (w/w) inorganic binder, wherein
   the ratio of inorganic binder to organic binder is greater than 1:1.

The ratio of inorganic to organic binder may be greater than 1:1 to about 10:1, typically about 2:1 to 10:1, preferably about 3:1 to 8:1. In other words, there is more inorganic binder present than organic binder.

The polyhalite composition may comprise polyhalite, or polyhalite in combination with potassium salt/s. The polyhalite composition may consist essentially of polyhalite. The polyhalite composition may consist of polyhalite.

The polyhalite composition may comprise 8.0% (weight for weight) (w/w) to 98.0% (w/w) polyhalite in combination with 92.0% (w/w) to 2.0% (w/w) potassium salt/s; 30.0% (w/w) to 80.0% (w/w) polyhalite in combination with 70.0% (w/w) to 20.0% (w/w) potassium salt/s, preferably 50.0% (w/w) to 80.0% (w/w) polyhalite in combination with 50.0% (w/w) to 20.0% (w/w) potassium salt/s, more preferably 50.0% (w/w) to 70.0% (w/w) polyhalite in combination with 50.0% (w/w) to 30.0% (w/w) potassium salt/s, more preferably 60.0% (w/w) to 70.0% (w/w) polyhalite in combination with 40.0% (w/w) to 30.0% (w/w) potassium salt/s, typically about 65.0% (w/w) polyhalite in combination with 35.0% (w/w) potassium salt/s.

The potassium salt/s may be selected from potassium chloride, potassium nitrate, potassium sulphate or combinations thereof, preferably potassium chloride.

The organic binder may be natural starch, modified starch, pre-gel starch (Pre-gel starch is starch that has been precooked and dried to enhance its thickening and water absorption capacity at lower temperatures), corn, potato, manioc, tapioca, rice starch or any combination thereof, hydrogels, carboxy methyl cellulose, Mg-lignosulphonate, Na-lignosulphonate, Ca-lignosulphonate and chitosan, or any combination thereof. The starch may be pre-treated with sodium hydroxide (NaOH) to promote low temperature gelatinisation of the starch and resultant changes in rheological profile.

In a preferred embodiment of the present invention the organic binder is carboxy methyl cellulose. The carboxy methyl cellulose may have a weight from (and including) about 90,000 to about 750,000.

The inorganic binder may be selected from gypsum, anhydrite, Na-bentonite, magnesium oxideplaster of paris, single super phosphate, magnesium phosphate, aluminum silicate, sodium silicate, potassium silicate, kaolin, micas, syngenite, other forms of polyhalite (including calcinated polyhalite, hydrated polyhalite), magnesium sulphate or a combination thereof.

Preferred inorganic binders are the α-hemihydrate or Beta-hemihydrate of gypsum, anhydrite, magnesium oxide, single super phosphate, magnesium phosphate, syngenite, forms of polyhalite (including calcined polyhalite, hydrated polyhalite), magnesium sulphate (as anhydrous and in the monohydrate form) or a combination thereof, preferably α-hemihydrate gypsum.

The granular material (granules) may further comprise boron, such as borax, colemanite, ulexite, or any combination thereof, and/or zinc oxide or zinc sulphate.

The boron may be present in an amount of 0.1% (w/w) to 1.0% (w/w), preferably 0.2% (w/w) to 0.8% (w/w) and even more preferably 0.3% (w/w) to 0.5% (w/w).

The zinc may be present in an amount of 0.1% (w/w) to 1.0% (w/w), preferably 0.1% (w/w) to 0.5% (w/w) and even more preferably 0.1% (w/w) to 0.3% (w/w).

The polyhalite granules may typically have a particle size range of 1.0 mm to 6.0 mm, preferably from 2.5 mm to 4.0 mm, and even more preferably 2.7 mm to 3.1 mm.

The average particle size of the polyhalite granules is from 1 mm to 1.9 mm, preferably 2 mm to 2.4 mm, preferably 2.5 mm to 3.5 mm, preferably from 2.6 mm to 3.1 mm, and even more preferably 2.70 mm to 2.80 mm.

The polyhalite granules according to the invention may have a crush strength of from about 2 kgf to about 6 kgf, more preferably from about 2.5 kgf to about 5 kgf and most preferably from about 3.0 kgf to about 4 kgf. In one embodiment of the present invention the polyhalite granules have a crush strength of above about 5 kgf.

Without being bound by theory, the applicants believe that the abovementioned parameters result in an improved product having improved abrasion resistance and improved coating properties (i.e. the ability to be coated). This is thought to be due to the granules assuming a more smooth, spherical shape which is easier to coat and less likely to become abraded. In this regard, it is preferred that the inorganic fraction is greater than the organic fraction in the binder.

According to a second aspect to the present invention there is provided a process for the preparation of polyhalite granules according to the first aspect of the present invention, the process comprising the steps of:
(a) mixing
   (i) a polyhalite composition;
   (ii) from 0.2% (w/w) to 2.0% % (w/w) organic binder;
   (iii) from 0.5% (w/w) to 6.0% (w/w) inorganic binder, wherein the ratio of inorganic binder to organic binder is greater than 1:1; and
   (iv) from 0% (w/w) to 14% (w/w) water, to obtain a polyhalite mixture; and
(b) granulating the polyhalite mixture to produce a polyhalite granules.

The polyhalite composition may be added to a granulator to produce the polyhalite granules.

The ratio of inorganic to organic binder may be greater than 1:1 to about 10:1, typically about 2:1 to 10:1, preferably about 3:1 to 8:1. In other words, there is more inorganic binder present than organic binder.

The polyhalite composition may comprise polyhalite, or polyhalite in combination with potassium salt/s. The polyhalite composition may consist essentially of polyhalite. The polyhalite composition may consist of polyhalite.

The polyhalite composition may comprise 8.0% (weight for weight) (w/w) to 98.0% (w/w) polyhalite in combination with 92.0% (w/w) to 2.0% (w/w) potassium salt/s; 30.0% (w/w) to 80.0% (w/w) polyhalite in combination with 70.0% (w/w) to 20.0% (w/w) potassium salt/s, preferably 50.0% (w/w) to 80.0% (w/w) polyhalite in combination with 50.0% (w/w) to 20.0% (w/w) potassium salt/s, more preferably 50.0% (w/w) to 70.0% (w/w) polyhalite in combination with 50.0% (w/w) to 30.0% (w/w) potassium salt/s, more preferably 60.0% (w/w) to 70.0% (w/w) polyhalite in combination with 40.0% (w/w) to 30.0% (w/w) potassium salt/s, typically about 65.0% (w/w) polyhalite in combination with 35.0% (w/w) potassium salt/s.

The potassium salt/s may be selected from potassium chloride, potassium nitrate, potassium sulphate or combinations thereof, preferably potassium chloride.

The organic binder may be natural starch, modified starch, pre-gel starch (Pre-gel starch is starch that has been precooked and dried to enhance its thickening and water absorption capacity at lower temperatures), corn, potato, manioc, tapioca, rice starch or any combination thereof, hydrogels, carboxy methyl cellulose, Mg-lignosulphonate, Na-lignosulphonate, Ca-lignosulphonate and chitosan, or any combination thereof. The starch may be pre-treated with sodium hydroxide (NaOH) to promote low temperature gelatinisation of the starch and resultant changes in rheological profile.

In a preferred embodiment of the present invention the organic binder is carboxy methyl cellulose. The carboxy methyl cellulose may have a weight from (and including) about 90,000 to about 750,000.

The inorganic binder may be selected from gypsum, anhydrite, Na-bentonite, magnesium oxideplaster of paris, single super phosphate, magnesium phosphate, aluminum silicate, sodium silicate, potassium silicate, kaolin, micas, syngenite, other forms of polyhalite (including calcinated polyhalite, hydrated polyhalite), magnesium sulphate or a combination thereof.

Preferred inorganic binders are the α-hemihydrate or Beta-hemihydrate of gypsum, anhydrite, magnesium oxide, single super phosphate, magnesium phosphate, syngenite, forms of polyhalite (including calcined polyhalite, hydrated polyhalite), magnesium sulphate (as anhydrous and in the monohydrate form) or a combination thereof, preferably α-hemihydrate gypsum.

The granular material (granules) may further comprise boron, such as borax, colemanite, ulexite, or any combination thereof, and/or zinc oxide or zinc sulphate.

The boron may be present in an amount of 0.1% (w/w) to 1.0% (w/w), preferably 0.2% (w/w) to 0.8% (w/w) and even more preferably 0.3% (w/w) to 0.5% (w/w).

The zinc may be present in an amount of 0.1% (w/w) to 1.0% (w/w), preferably 0.1% (w/w) to 0.5% (w/w) and even more preferably 0.1% (w/w) to 0.3% (w/w).

The process according to this aspect of the invention may have a granulation efficiency of at least about 40%, more preferably about 55% and more preferably about 70%.

Granulation efficiency is the % of the granules in the end of the granulator that achieves the size that is considered acceptable product. For the present invention, consider particles between 4 and 2 mm are preferred.

The polyhalite granules produced in step (b) may be dried in a drying device.

According to a third aspect to the present invention there is provided a granule comprising polyhalite in combination with potassium salt/s having a crush strength of from 2.0 kgf to 6.0 kgf and a final moisture content of from 0.25 to 0.50% w/w.

### BRIEF DESCRIPTION OF THE DRAWINGS

The present invention will be fully understood from the detailed description given herein and from the accompanying drawing and results which are given only as an illustration and that is not limit the intended scope of invention.

FIG. 1 is a flow diagram of a process for producing polyhalite granules of the present invention;

FIG. 2 is polyhalite+potassium chloride (65:35 w/w) granules produced by Experiments 3, 14 and 14′;

FIG. 3 is polyhalite+potassium chloride (65:35 w/w) granules produced by Experiments 5, 15 and 16;

FIG. 4 is polyhalite+potassium chloride (65:35 w/w) granules produced by Experiments 19 and 20;

FIG. 5 is polyhalite+potassium chloride (65:35 w/w) granules produced by Experiments 4, 21, 22, 23, 24, 25, 26 and 29;

FIG. 6 is polyhalite+potassium chloride (65:35 w/w) granules produced by Experiments 17 and 18;

FIG. 7 is polyhalite+potassium chloride (65:35 w/w) granules produced by Experiment 32;

FIG. 8 is a graph showing granulation efficiency (%) and crush strength (kgf) for Experiments 1 to 32;

FIG. 9 shows the processing conditions for further experiments;

FIG. 10 shows the properties of the polyhalite granules produced of the further Experiments 03, 04 and 05.

### DESCRIPTION OF PREFERRED EMBODIMENTS

The present invention relates to the granulation of polyhalite (Polyhalite is a hydrated evaporate rnineralcomprising of sulphate of potassium, calcium and magnesium with formula K₂Ca₂Mg(SO₄)₄·2H2O), or polyhalite in combination with a potassium salt (a muriate of potash), preferably potassium chloride, using organic and inorganic materials combined as binders to improve the granulation and final product quality. The organic and inorganic additives or binders can be either in a solid or liquid phase. The liquid phase can be a suspension or a diluted material in water. The starch can also be pre-treated in a sodium hydroxide solution. The granulation can be affected in a drum, pan, fluid bed, high shear, extruder, paddle mix, spheronizer or any other type of granulator. The granulation can occur with steam or no steam, preferably at temperature of at least 30° C. (deg C.).

The present invention may reduce dust generation and minimize the reduction of crush strength with time. Better shaped granules, for example more rounded particles, can also be produced. The combination of inorganic and organic binders can reduce the moisture uptake of the final product and/or its kinetics. In addition, this may also lower the dependency on the need for high dosages of other additives/chemicals, such as coatings, that only help to prevent a deterioration of a granules once made.

Organic binders assist in the granulation process by binding the polyhalite and potassium salt during agglomeration, and may be selected from natural starch, modified starch, pre-gel starch (Pre-gel starch is starch that has been precooked and dried to enhance its thickening and water absorption capacity at lower temperatures), corn, potato, manioc, tapioca, rice starch or any combination thereof, hydrogels, carboxy methyl cellulose, Mg-lignosulphonate, Na-lignosulphonate, Ca-lignosulphonate and chitosan, or any combination thereof. The starch may be pre-treated with sodium hydroxide (NaOH) to promote low temperature gelatinisation of the starch and resultant changes in rheological profile. In a preferred embodiment of the present invention the organic binder is carboxy methyl cellulose. The carboxy methyl cellulose may have a weight from (and including) about 90,000 to about 750,000.

In accordance with the process of the present invention, it has been found that the combination of an organic binder with an inorganic binder improves not only the granulation process, but also the crush strength. It has, surprisingly, been found that Gypsum, a soft sulfate mineral composed of calcium sulfate dihydrate, with the chemical formula CaSO4·2H2O, increases the granulation efficiency of the process and yield a high crush strength. Without wishing to be bound by theory, it is believed that the increase in crush strength is due to crystal bridge formation through reaction or hydration of the mineral, which surprisingly occurs without the presence of an acid for reaction to occur. The α-hemihydrate gypsum is preferred due to its crystalline structure. Beta-hemihydrate consists of fine aggregates. In contrast, alpha-hemihydrate consists of coarse grains which are well-defined crystals. Other inorganic binders that are expected to act in the same way are anhydrite, magnesium oxide, single super phosphate, magnesium phosphate, syngenite, forms of polyhalite (including calcined polyhalite, hydrated polyhalite), magnesium sulphate (as anhydrous and in the monohydrate form) or a combination thereof.

The ratio of the binders included in the granules has a surprising effect on the granules, where the best of each binder can be achieved If the correct proportion between organic and inorganic binders is added in the granulation. It can mean to reach higher crush strengths (using the organic) and compacted and smooth grains and easier granulation (using inorganic). The organic:inorganic ratios will depend on the inorganic binder chosen. Organic binders are used in 1.5% w/w or less, while the inorganic binder can reach additions until 6% w/w. The ratio of inorganic:organic binder more suitable seems to be between 3:1 and 8:1.

Granulation efficiency is the % of the granules in the end of the granulator that achieves the size that is considered acceptable product. For the present invention, consider particles between 4 and 2 mm are preferred.

The polyhalite granules according to the invention may have a crush strength of from about 2 kgf to about 6 kgf, more preferably from about 2.5 kgf to about 5 kgf and most preferably from about 3.0 kgf to about 4 kgf. In one embodiment of the present invention the polyhalite granules have a crush strength of above about 5 kgf.

The kilogram-force (kgf) is a metric unit of force and equal to the magnitude of the force exerted on one kilogram of mass in a 9.80665 m/s² gravitational field. Therefore, one kilogram-force is equal to 9.80665 N.

Crushing strength is a measure of the resistance of granules to deformation or fracture under pressure. Crushing strength is of interest in estimating the expected handling and storage properties of a granular material and determining the pressure limits applied during bag and bulk storage. A preferred procedure states that more than 25 granules (normally 30) between 2.36 mm and 2.79 mm are submitted to pressure until breakage is observed. The force applied to break the granule is the crush strength (Granule Crushing Strength—IFDC Methodology S-115).

The granules may further include nutrients including macronutrients/micronutrients selected from:
potassium sulphate, potassium chloride, langbeinite, potassium nitrate etc.,
Sulphur (elemental sulphur, ammonium sulphate), and
Urea

Optional additional components to the granules may be one or more of:
Boron (borax, colemanite, ulexite),
Zinc (zinc oxide, zinc sulphate), and
Magnesium (magnesium oxide, kieserite, magnesite).

### EXAMPLES

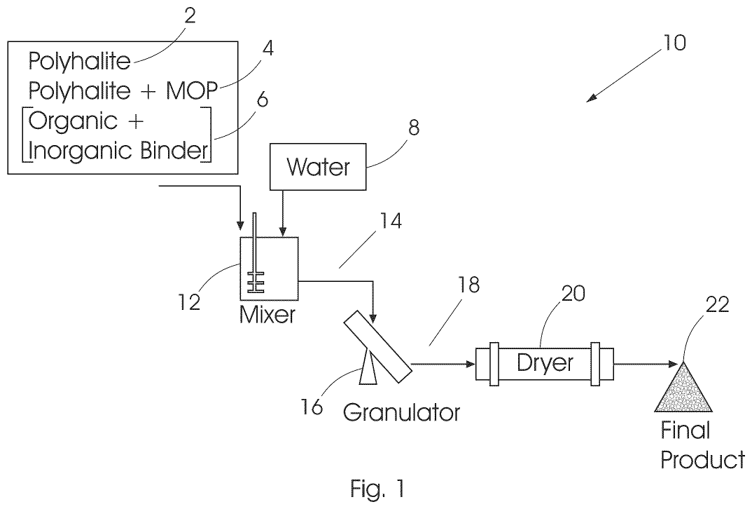

FIG. 1 shows the diagrammatic process for each of the experiments. FIG. 1 shows a process for the preparation of polyhalite granules according to the invention (10) wherein a mixture of polyhalite (2), polyhalite and potassium salts (4) and a mixture or organic and inorganic binder (6) together with water (8) are added to an Eirich® intensive mixer (12) and thereafter transferred (14) a pan granulator, (16). It will be appreciated that different granulating equipment can be used for example, a drum granulator, pan granulator, Eirich® high share, spheronizer, fluidized bed or any other kind of equipment or combination capable of producing granules. The wet granules are then transferred (18) to a dryer (20).

The drier conditions should be around 100° C. but it can also be done at lower temperatures (for example from 70-95° C.) but should not be higher than about 120° C. to avoid degradation or caramelization of the organic material.

Following drying, polyhalite granules according to the invention (20) are produced. Granulation efficiencies may be above 70-80% and crush strength above 4 kgf (39.23 N).

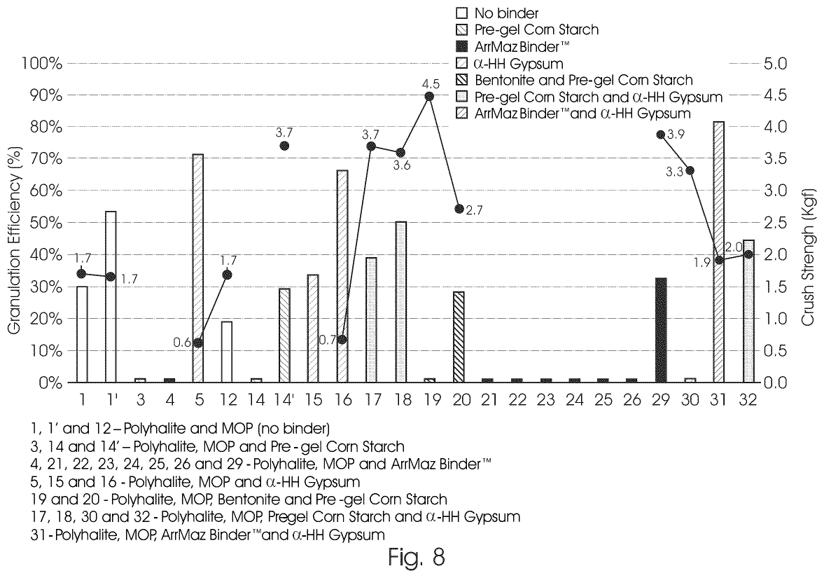

32 experiments were carried out adding different binders and combinations as follows, see FIG. 8:

Water is used at 90 deg Celsius for all experiments.

### Experiments 1, 1′ and 12—No Binder

No binder was used to produce the polyhalite and potassium chloride granules.

Polyhalite and potassium chloride (65:35 w/w); and water at a temperature of 90° C. was used in the granulation process to produce polyhalite and potassium chloride granulates. The crush strength of the granules for all three experiments was 1.7 kgf (16.67 N) and the granulation efficiency changed with the process conditions and water added during granulation.

| | | Granulation | Crush | Water | Granulation | Final Product |
|---|---|---|---|---|---|---|
| | | Efficiency | Strength | addition | time | moisture |
| Exp | Binder | (%) | (kgf) | (%) | (sec) | (%) |
| 1 | no | 30% | 1.7 | 7.5 | 300 | 0.28 |
| 1′ | no | 53% | 1.7 | 6.5 | 360 | 0.33 |
| 12 | no | 19% | 1.7 | 7.5 | 360 | 0.27 |

Experiments 3, 14 and 14′—Pre-gel corn starch

Polyhalite, potassium chloride, pre-gel corn starch and water at a temperature of 90° C. was used in the granulation process to produce polyhalite granules. The crush strength of the granules was 3.7 kgf (36.28 N) and was reached when water was added at 7 wt % (Experiment 14′). Experiments 3 and 14 did not generate granules with a desirable particle size distribution (9% and 7.5% of water added respectively) and had roughness on the surface of the granules. The granulated polyhalite and potassium chloride product is shown in FIG. 2.

| | | | | | | | Final |
|---|---|---|---|---|---|---|---|
| | | | Granulation | Crush | Water | Granulation | Product |
| | | Binder | Efficiency | Strength | addition | time | moisture |
| Exp | Binder | (kg/t) | (%) | (kgf) | (%) | (sec) | (%) |
| 3 | Pre-gel | 20 | 1% | 2.4 | 9.0 | 360 | 0.44 |
| | corn | | | | | | |
| | starch | | | | | | |
| 14 | Pre-gel | 20 | 0% | na | 7.5 | 480 | na |
| | corn | | | | | | |
| | starch | | | | | | |
| 14′ | Pre-gel | 20 | 29% | 3.7 | 7.0 | 480 | 0.50 |
| | corn | | | | | | |
| | starch | | | | | | |

Experiments 5, 15 and 16—α-HH gypsum

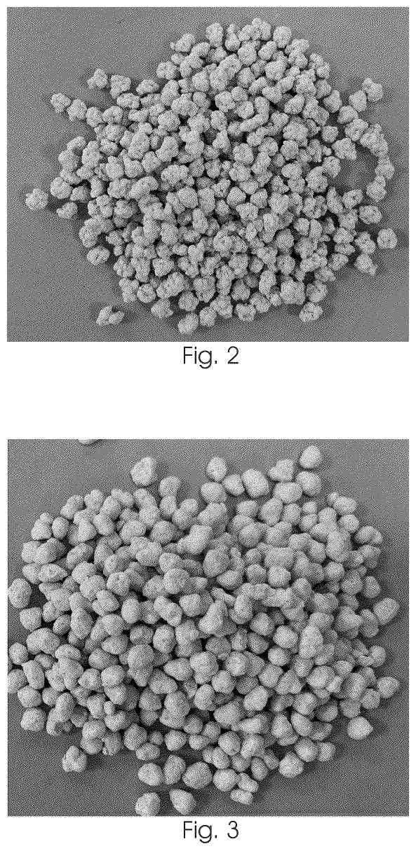

Polyhalite, potassium chloride, α-HH gypsum and water at levels of 7.2, 7.0 and 7.5% for Experiments 5, 15 and 16, respectively, was used in the granulation process to produce polyhalite and potassium chloride granules. Crush strength was very low—around 0.6-0.7 kgf (5.88-6.86 N). Granules were smooth and easy to granulate. It was observed that α-HH gypsum provided less hygroscopic behavior. The granulated polyhalite product is shown in FIG. 3.

| | | | | | | | Final |
|---|---|---|---|---|---|---|---|
| | | | Granulation | Crush | Water | Granulation | Product |
| | | Binder | Efficiency | Strength | addition | time | moisture |
| Exp | Binder | (kg/t) | (%) | (kgf) | (%) | (sec) | (%) |
| 5 | α-HH | 40 | 71% | 0.6 | 7.0 | 360 | 0.31 |
| | Gypsum | | | | | | |
| 15 | α-HH | 20 | 33% | 0.6 | 7.2 | 540 | 0.27 |
| | Gypsum | | | | | | |
| 16 | α-HH | 40 | 66% | 0.7 | 7.5 | 360 | 0.25 |
| | Gypsum | | | | | | |

### Experiments 19 and 20—Bentonite and Starch

Previous experiences showed bentonite helps the granulation but does not help the crush strength. Starch was added to help with the crush strength in combination with bentonite. Polyhalite, potassium chloride, bentonite, starch and water were used in the granulation process to produce polyhalite and potassium chloride granules. The use of different organic and inorganic binders positively affected the product hardness, the granulation behaviour and the physical aspect of the final product.

| | | | | | | | Final |
|---|---|---|---|---|---|---|---|
| | | | Granulation | Crush | Water | Granulation | Product |
| | | Binder | Efficiency | Strength | addition | time | moisture |
| Exp | Binder | (kg/t) | (%) | (kgf) | (%) | (sec) | (%) |
| 19 | Pre-gel | 10 kg/t | 1% | 4.5 | 7.5 | 240 | 0.40 |
| | corn | 30 kg/t | | | | | |
| | starch/ | | | | | | |
| | Bentonite | | | | | | |
| 20 | Pre-gel | 10 kg/t | 28% | 2.7 | 6.4 | 420 | 0.60 |
| | corn | 20 kg/t | | | | | |
| | starch/ | | | | | | |
| | Bentonite | | | | | | |

The resultant granulations did not reach the best liquid phase conditions. The granulation efficiency can be improved by changing the process conditions. The highest crush strength was found at experiment 19, being 4.5 kgf (44.13 N).

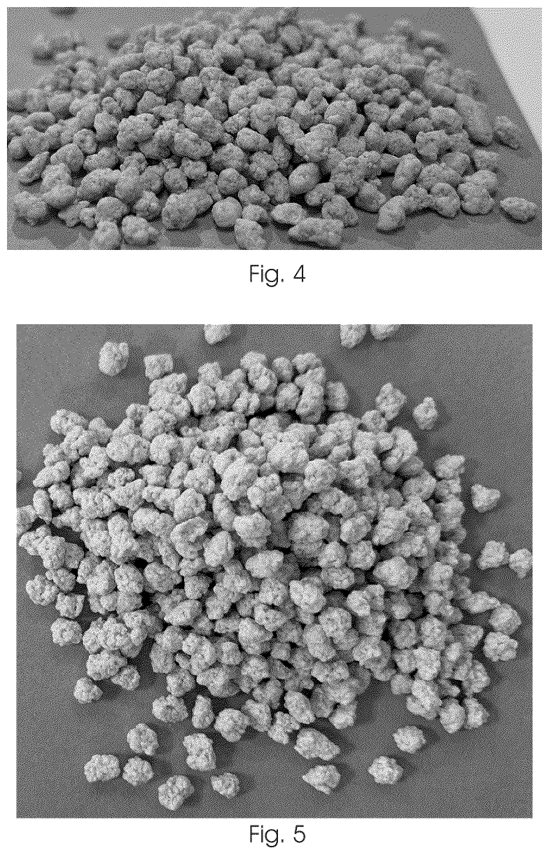

The granulated polyhalite product is shown in FIG. 4.

### Experiments 4, 21, 22, 23, 24, 25, 26 and 29—ArrMaz Binder™

Polyhalite and potassium chloride, ArrMaz Binder™ (an organic binder including carboxy methyl cellulose), and water was used in the granulation process to produce polyhalite and potassium chloride granules. (“™” is to be considered a designation of a Registered Trade Mark (RTM)). The granulation was successful due to the behaviour of the binder. Small changes in the granulation temperature seemed to have an impact on granulation efficiency and product behavior that change from very difficult to granulate (just fines formed) to very easy and fast to granulate, resulting in a big dry ball in seconds, after small amounts of water addition. The granulation curve looks to be tiny, passing from fines to courses very easily. Grains formed did not have a smoothy surface, but despite of this, the binder resulted in a positive impact on crush strength of the final product.

| | | | | | | | Final |
|---|---|---|---|---|---|---|---|
| | | | Granulation | Crush | Water | Granulation | Product |
| | | Binder | Efficiency | Strength | addition | time | moisture |
| Exp | Binder | (kg/t) | (%) | (kgf) | (%) | (sec) | (%) |
| 4 | ArrMaz | 20 | 0% | na | 11.5 | 480 | na |
| | Binder ™ | | | | | | |
| 21 | ArrMaz | 15 | 0% | na | 12.5 | 600 | na |
| | Binder ™ | | | | | | |
| 22 | ArrMaz | 15 | 0% | na | 11.0 | 360 | na |
| | Binder ™ | | | | | | |
| 23 | ArrMaz | 15 | 0% | na | 12.5 | 540 | na |
| | Binder ™ | | | | | | |
| 24 | ArrMaz | 15 | 0% | na | 12.5 | 600 | na |
| | Binder ™ | | | | | | |
| 25 | ArrMaz | 15 | 0% | na | 12.3 | 240 | na |
| | Binder ™ | | | | | | |
| 26 | ArrMaz | 15 | 0% | na | 11.0 | 240 | na |
| | Binder ™ | | | | | | |
| 29 | ArrMaz | 10 | 32% | 3.9 | 10.5 | 600 | 0.32 |
| | Binder ™ | | | | | | |

The granulated polyhalite product is shown in FIG. 5.

### Experiments 17,18 and 32—α-HH Gypsum and Starch

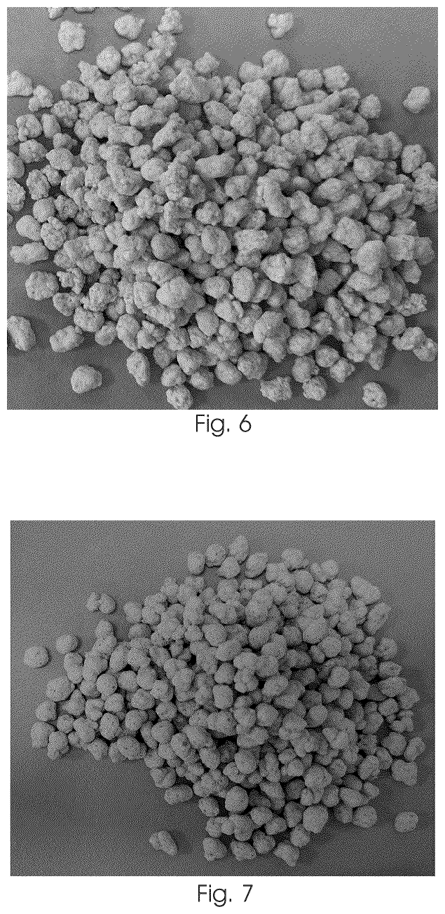

Polyhalite, potassium chloride, α-HH gypsum, starch and water was used in the granulation process to produce polyhalite and potassium chloride granules. Easier behavior to granulate, high crush strength (3.7, 3.6 and 2.0 kgf (36.28, 35.30; 19.61 N) for Experiments 17, 18 and 32 respectively), and granulation efficiency between 39-50%. The particles of the polyhalite and potassium chloride mixture produced were rounder than using pre-gel corn starch alone and easier to granulate. The polyhalite and potassium chloride granules had good crush strength (which was not reached with the α-HH gypsum alone). The granulated polyhalite product is shown in FIGS. 6 and 7.

The use of different organic and inorganic binders affected the product hardness, the granulation behavior and the physical aspect of the final product.

| | | | | | | | | Final |
|---|---|---|---|---|---|---|---|---|
| | | | | Granulation | Crush | Water | Granulation | Product |
| | | Binder | | Efficiency | Strength | addition | time | moisture |
| Exp | Binder | (kg/t) | Micro | (%) | (kgf) | (%) | (sec) | (%) |
| 17 | Pre-gel | 10 kg/t | na | 39% | 3.7 | 7.7 | 300 | 0.5 |
| | corn | 30 kg/t | | | | | | |
| | starch/ | | | | | | | |
| | α-HH | | | | | | | |
| | Gypsum | | | | | | | |
| 18 | Pre-gel | 10 kg/t | na | 50% | 3.6 | 7.5 | 480 | 0.49 |
| | corn | 30 kg/t | | | | | | |
| | starch/ | | | | | | | |
| | α-HH | | | | | | | |
| | Gypsum | | | | | | | |
| 32 | Pre-gel | 05 kg/t | Borax/ | 44% | 2.0 | 11.2 | 360 | 0.40 |
| | corn | 40 kg/t | Ulexite | | | | | |
| | starch/ | | 50 kg/t/ | | | | | |
| | α-HH | | 50 kg/t | | | | | |
| | Gypsum | | | | | | | |

### Experiment 31—α-HH Gypsum and ArrMVAz Binder™

Polyhalite, potassium chloride, α-HH gypsum, ArrMaz Binder™ and water was used in the granulation process to produce polyhalite and potassium chloride granules. The ratio of organic:inorganic binder and process conditions can be manipulated to achieve the highest crush strength, best physical characteristics and a higher granulation efficiency. The preliminary results suggest organic:inorganic ratios will depend on the inorganic binder chosen. Organic binders are used in 1.5% w/w or less, while the inorganic binder can reach additions until 6% w/w. The ratio of inorganic:organic binder more suitable seems to be between 3:1 and 8:1.

| | | | | | | | Final |
|---|---|---|---|---|---|---|---|
| | | | Granulation | Crush | Water | Granulation | Product |
| | | Binder | Efficiency | Strength | addition | time | moisture |
| Exp | Binder | (kg/t) | (%) | (kgf) | (%) | (sec) | (%) |
| 31 | Pre-gel | 05 kg/t | 81% | 1.9 | 8.9 | 240 | 0.32 |
| | corn | 40 kg/t | | | | | |
| | starch/ | | | | | | |
| | α-HH | | | | | | |
| | Gypsum | | | | | | |

The use of different organic and inorganic binders affected the product hardness, the granulation behaviour and the physical aspects of the final product.

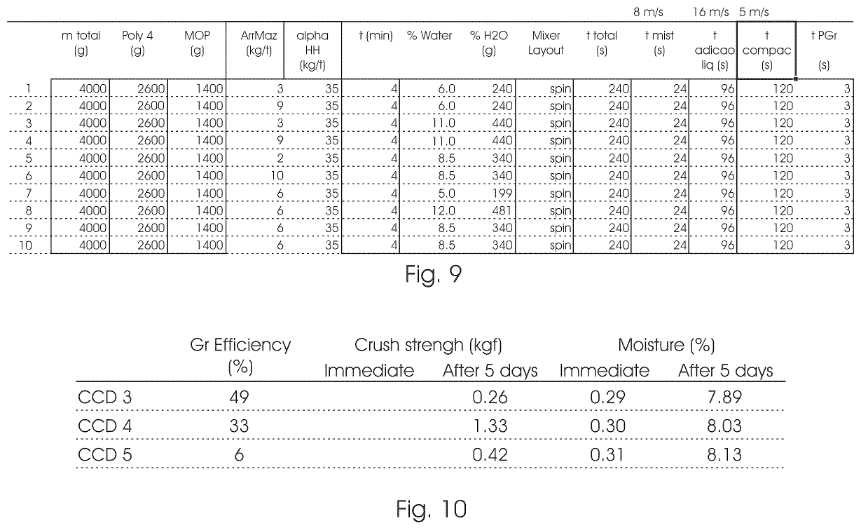

Based on the above Experiments, further experiments were carried out to understand granulation behavior, crush strength, liquid phase, product characteristics and granulation efficiency, changing the ratio between organic and inorganic binder. In this case, the combination of α-HH gypsum and ArrMaz Binder™ was chosen. A Central Composite Design (CCD) with 2 variables (organic:inorganic binder ratio and water addition) was proceeded with 2 replicas in the central point. The granulation time used to carry out the experiments was fixed at 7 min (4 min in the intensive mixer plus 3 min in a pan granulator), the polyhalite and potassium chloride ratio was the same for all CCD (polyhalite:potassium chloride—65:35) and the mixture, liquid addition and compaction time during granulation were also fixed. The processing conditions for the further experiments are shown in FIG. 9.

The results of the polyhalite and potassium chloride granules product is shown in FIG. 10. Unfortunately, all CCD experiments except Experiments number 3, 4 and 5 resulted in fines or courses, and it was not possible to determine the properties of the final product or to proceed with the statistical evaluations. The granulated polyhalite and potassium chloride product is shown in FIG. 11.

| | | | | | | | Final |
|---|---|---|---|---|---|---|---|
| | | | | Granulation | Water | Granulation | Product |
| | | Binder | Org:Inorg | Efficiency | addition | time | moisture |
| Exp | Binder | (kg/t) | Ratio | (%) | (%) | (sec) | (%) |
| 3 | ArrMaz | 3 kg/t/ | 1:12 | 49% | 11.0 | 420 | 0.29 |
| | Binder ™/ | 35 kg/t | | | | | |
| | α-HH | | | | | | |
| | Gypsum | | | | | | |
| 4 | ArrMaz | 9 kg/t/ | 1:4 | 33% | 11.0 | 420 | 0.3 |
| | Binder ™/ | 35 kg/t | | | | | |
| | α-HH | | | | | | |
| | Gypsum | | | | | | |
| 5 | ArrMaz | 2 kg/t/ | 1:18 | 6% | 8.5 | 420 | 0.31 |
| | Binder ™/ | 35 kg/t | | | | | |
| | α-HH | | | | | | |
| | Gypsum | | | | | | |

Based on the results, the ratio of the binders included in the granules has a surprising effect on the granules, where the best of each binder can be achieved If the correct proportion between organic and inorganic binders is added in the granulation. It can mean to reach higher crush strengths (using the organic) and compacted and smooth grains and easier granulation (using inorganic).

Experiments 32-35 Polyhalite with Inorganic and Organic Binders

Polyhalite (100%) with combinations of organic/inorganic binders and water was used in the granulation process to produce polyhalite granules. The ratio of organic:inorganic binder and process conditions can be manipulated to achieve the highest crush strength, best physical characteristics and a higher granulation efficiency. The preliminary results suggest organic:inorganic ratios will depend on the inorganic binder chosen. Organic binders are used in 1.5% w/w or less, while the inorganic binder can reach additions until 6% w/w. The ratio more suitable is a ratio of inorganic to organic binder of greater than 1:1.

| | | | | | Physical | | |
|---|---|---|---|---|---|---|---|
| | | | | | Characteristic | | |
| | | | Granulation | Crush | (subjective | Water | Granulation |
| | | | Efficiency | Strength | based on | addition | time |
| Exp | Binder | kg/t | (%) | (kgf) | imagery) | (%) | (sec) |
| 32 | Starch/ | 5 | 48% | 1.7 | More uniform | 8.3 | 560 |
| | Bentonite | 10 | | | than Starch | | |
| 33 | Starch/ | 5 | 44% | 4 | Smoother, | 7 | 270 |
| | α-HH | 20 | | | more | | |
| | | | | | spherical | | |
| | | | | | than starch | | |
| 34 | CMC90 | 5 | 57% | 3.4 | More uniform | 10.3 | 270 |
| | Bentonite | 10 | | | than Starch | | |
| 35 | CMC90/ | 5 | 75% | 5.5 | Smoother, | 9 | 270 |
| | α-HH | 10 | | | more | | |
| | | | | | spherical | | |
| | | | | | than starch | | |

1-84. (canceled)

85. A granular material comprising:
i. a polyhalite composition;
ii. 0.2% (w/w) to 2.0% (w/w) organic binder; and
iii. 0.5% (w/w) to 6.0% (w/w) inorganic binder; wherein
the ratio of inorganic binder to organic binder is greater than 1:1.

86. The material according to claim 85, wherein the ratio of inorganic to organic binder is greater than 1:1 to about 10:1.

87. The material according to claim 85, wherein the polyhalite composition comprises polyhalite, or polyhalite in combination with potassium salt/s.

88. The material according to claim 85, wherein the polyhalite composition comprises 8.0% (weight for weight) (w/w) to 98.0% (w/w) polyhalite in combination with 92.0% (w/w) to 2.0% (w/w) potassium salt/s.

89. The material according to claim 87, wherein the potassium salt/s is/are selected from potassium chloride, potassium nitrate, potassium sulphate or combinations thereof.

90. The material according to claim 85, wherein organic binder is natural starch, modified starch, pre-gel starch, corn, potato, manioc, tapioca, rice starch or any combination thereof, hydrogels, carboxy methyl cellulose, Mg-lignosulphonate, Na-lignosulphonate, Ca-lignosulphonate and chitosan, or any combination thereof.

91. The material according to claim 85, wherein the inorganic binder is selected from gypsum, anhydrite, Na-bentonite, magnesium oxideplaster of paris, single super phosphate, magnesium phosphate, aluminum silicate, sodium silicate, potassium silicate, kaolin, micas, syngenite, other forms of polyhalite (including calcinated polyhalite, hydrated polyhalite), magnesium sulphate or a combination thereof.

92. The material according to claim 85, further comprising boron, colemanite, ulexite, or any combination thereof, and/or zinc oxide or zinc sulphate.

93. The material according to claim 85, wherein the granules have a particle size range of 1.0 mm to 6.0 mm.

94. The material according to claim 85, wherein the granules have a crush strength of from about 2 kgf to about 6 kgf.

95. A process for the preparation of polyhalite granules, the process comprising the steps of:
(a) mixing
(i) a polyhalite composition;
(ii) from 0.2% (w/w) to 2.0% % (w/w) organic binder;
(iii) from 0.5% (w/w) to 6.0% (w/w) inorganic binder, wherein the ratio of inorganic binder to organic binder is greater than 1:1; and
(iv) from 0% (w/w) to 14% (w/w) water,
to obtain a polyhalite mixture; and
(b) granulating the polyhalite mixture to produce a polyhalite granules.

96. The process according to claim 95, wherein the polyhalite mixture is added to a granulator to produce the polyhalite granules.

97. The process according to claim 95, wherein the polyhalite composition comprises polyhalite, or polyhalite in combination with potassium salt/s.

98. The process according to claim 95, wherein the polyhalite granules produced in step (b) are dried in a drying device.

99. A granule comprising polyhalite or polyhalite in combination with potassium salt/s having a crush strength of from 2.0 kgf to 6.0 kgf and a final moisture content of from 0.25 to 0.50% w/w.
